(19) United States
(12) Patent Application Publication
(10) Pub. No.: US 2008/0189123 A1
(43) Pub. Date: Aug. 7, 2008

(54) Career database system and method

(76) Inventor: Bryant Wong, Foster City, CA (US)

Correspondence Address: BARBER LEGAL, P.O. BOX 16220, GOLDEN, CO, 80402-6004, US

(21) Appl. No.: 11/703,271

(22) Filed: Feb. 7, 2007

(51) Int. Cl. G06Q 10/00

(52) U.S. Cl. 705/1

(57) ABSTRACT

A website provides multi-level recruiting of job seekers/marketing of employment opportunities. A registered job seeker may refer other job seekers to opportunities available on the website and receive a finder's fee if the referee is hired for the position. The model may be extended to multiple levels of finder's fees, and deferred hires or advanced referrals, even cases in which the referral occurs before the job opening itself. The device of the invention may be website having modules for registration, referrals, databases of resumes, employment opportunities and webs of referrals, as well as a payment module. The method of the invention may be registering a job seeker, registering referred parties of that job seeker and other parties who are indirect referrals via the directly referred parties, and paying finder's fees as appropriate to parties above hired parties.

### CROSS-REFERENCE TO RELATED APPLICATIONS

The application claims the priority and benefit of U.S. Provisional Patent Application No. 60/766,682 filed Feb. 6, 2006 in the name of the same inventor, Bryant Wong, and entitled METHOD AND SYSTEM TO ACQUIRE A DATABASE OF JOB SEEKERS AND/OR RESUMES TO BE USED IN CAREER PLACEMENT, EMPLOYMENT, JOB MATCHING, JOB PLACEMENT, AND/OR STAFFING RELATED SERVICES, the entire disclosure of which in incorporated herein by this reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE INVENTION

This, invention relates generally to career development devices and methods, and specifically to websites and databases of resumes relating to career development devices and methods.

### STATEMENT REGARDING FEDERALLY FUNDED RESEARCH

This invention was not made under contract with an agency of the US Government, nor by any agency of the US Government.

### BACKGROUND OF THE INVENTION

Career development/job placement web sites and computer systems generally are driven either top-down by employer/human resources requests for specific skills, with fees paid upon successful location of individuals with the required skills or else by a process of mass advertising to potential job seekers with the goal of acquiring a large database of job seekers. Some are done in combination. Other than advertising, there is little to alert job seekers as to what websites may be productive or “hot” from year to year, as the title of “best” or “biggest” website may change from year to year. A number of such websites are known.

Other computerized career development/human resources systems generally teach improved “matching” algorithms comparing resumes to job requirements.

U.S. Patent Publication No. 20060242014 to Marshall et al on Oct. 26, 2006 teaches referrals for job hunting, but without teaching that the pool of referring parties may themselves be job seekers who have registered at a resume posting website. Importantly, this item does not offer multi-level referral fees nor deferred referral fees in which the referred applicant might conceivably be referred years before the job opening even exists.

U.S. Patent Publication No. 20060206448 to Hyder et al on Sep. 14, 2006, teaches scraping of job related websites in order to cull a larger database, but does not teach a job seeker referral website.

U.S. Patent Publication No. 20020026452 to Baumgarten et al on Feb. 28, 2002, teaches a website of the “matching criteria” type which does not teach nor suggest that referrals may be used from job seekers.

U.S. Patent Publication No. 20020007301 to Reuning, published Jan. 17, 2002 and U.S. Pat. No. 6,381,592 to Reuning on Apr. 30, 2002, teaches that a web-crawler type device may search the web for sites thought to be relevant to a job opening and may then extract from such sites email addresses, after which spam emails are sent to the extracted addresses.

U.S. Pat. No. 7,149,703 to Younger on Dec. 12, 2006, teaches creation of a “virtual community” of individuals when a specific job opening comes in. At that point the virtual community is polled with a request for referrals. The '703 system thus does not teach an on-going search for referrals, nor does it actually teach referrals by job seekers themselves but rather by the “virtual community”, which may be “relevant” to the job opening but are not necessarily actual job seekers.

U.S. Pat. No. 6,457,005 to Torrey on Sep. 24, 2002, teaches a searchable database of job openings: searchers, who may be anyone, may refer individuals and if a match is made, the referring party may receive a fee.

U.S. Pat. No. 6,968,313 to Oran on Nov. 22, 2005, teaches management of webs of referrals themselves, rather than generation of referrals or any thing else relevant to job placement services.

U.S. Pat. No. 6,029,141 to Bezos et al on Feb. 22, 2000 teaches sales of documents via. links, and thus is not relevant to the present invention, as well as lacking the aspect of mutual consumer based referrals.

Thus while paying “head hunters” or other referring parties upon the hiring of successful candidates is known, the practice of actually offering job seekers themselves the chance to refer other job seekers is not taught in the prior art located to date. In general, job seekers have in the past had no incentive to provide tips about job opportunities to other job seekers. Yet for a number of reasons, job seekers are often in a better position than human resources professionals or “head hunters” to locate appropriate people for openings the job seeker may become aware of during their own search.

It would be advantageous to provide a system by which a job seeker at a resume posting website might refer another job seeker and collect a fee for that referral, and in which the fee may be paid to multiple levels of referrals, rather than to a single referral.

It would further be advantageous to provide a system by which a job seeker might receive deferred compensation for a referral, and in fact in which the referral might occur years before the hiring, or even in which the opening might occur after the referral.

It would further be advantageous to provide a system by which the diligence and contacts of job seekers themselves are harnessed to providing leads to qualified prospects for employment.

### SUMMARY OF THE INVENTION

General Summary

A website provides multi-level recruiting of job seekers or multi-level marketing of employment opportunities. The multi-level aspect harnesses the power of multi-level recruiting/marketing, while the fact that job seekers will refer other job seekers and receive a fee for the referrals is new to the online employment industry.

A registered job seeker may refer other job seekers to post their resumes to be available on the website and receive a finder's fee if the referee is hired for the position. The model may be extended to multiple levels of finder's fees, so that the first job hunter that locates a second job hunter may receive a fee from the employment of third parties referred, directly or indirectly, by the second job hunter. The fees may decrease as successive generations of job seekers intervene, or the fees may be curtailed at the first tier, or the fee may be a flat fee paid to every individual within a certain number of links above the hired individual.

The device of the invention may be website having modules for registration, referrals, databases of resumes, employment opportunities and webs of referrals, as well as a payment module. A job seeker/user will register at the website, may optionally provide their own resume/curriculum vitae (CV), and may optionally search job opportunities posted upon the website.

The method of the invention may be registering a job seeker, registering referred parties of that job seeker and other parties who are indirect referrals via the directly referred parties, and paying finder's fees as appropriate to parties above hired parties.

### SUMMARY IN REFERENCE TO CLAIMS

It is therefore another aspect, advantage, objective and embodiment of the invention, in addition to those discussed previously, to provide a resume collection system and database for use with a computer network and for use by employers and by first and second job seekers having a client computer operatively connected to such computer network; the resume collection system and database comprising:
a server computer having thereon a database and a website, the server computer operatively connected to such computer network and operative to provide the website to such client computer connected to the server computer via such computer network;
the website having at least a first registration module allowing such first job seeker to register their contact information;
the website having at least a second resume collection module allowing such first job seeker to post their resume/curriculum vitae to the database;
the website having at least a third invitation module allowing such first job seeker to refer such second job seeker to the website and allowing such second job seeker to use the modules of the website also;
the database maintaining a first relationship object indicating the identities of such first and second job seekers;
the website having at least a fourth payment module which, upon occurrence of a first triggering event pays to such first job seeker a first fee.

It is therefore a second aspect, advantage, objective and embodiment of the invention to provide a resume collection system and database wherein the triggering event further comprises:

hiring of such second job seeker.

It is therefore a third aspect, advantage, objective and embodiment of the invention to provide a resume collection system and database for use by a third job seeker, wherein the resume collection system and database further comprises:

a second relationship object indicating a relationship between such second job seeker and such third job seeker.

It is therefore yet another aspect, advantage, objective and embodiment of the invention to provide a resume collection system and database wherein the fourth payment module further is operative to pay a second fee to such first job seeker upon occurrence of a second triggering event.

It is therefore another aspect, advantage, objective and embodiment of the invention to provide a resume collection system and database wherein the second triggering event further comprises:

hiring of such third job seeker.

It is therefore yet another aspect, advantage, objective and embodiment of the invention to provide a resume collection system and database further comprising:
at least a fifth job posting module operative to allow such employers to post to the database a first job opportunity object.

It is therefore another aspect, advantage, objective and embodiment of the invention to provide a resume collection system and database further comprising:
at least a fifth job search module operative to allow the job seekers to search the database for the first job opportunity object.

It is therefore another aspect, advantage, objective and embodiment of the invention to provide a method of collecting resumes for a first, second and third job seeker, the method of collecting resumes comprising:
a) providing a website at which a first employer may post job opportunities;
b) registering such first job seeker;
c) allowing such first job seeker to refer such second job seeker;
d) if such second job seeker is hired by such first employer, paying,to such first job seeker a fee.

It is therefore another aspect, advantage, objective and embodiment of the invention to provide a method of collecting resumes further comprising:
e) allowing such second job seeker to refer such third job seeker;
f) if such third job seeker is hired by such first employer, paying to such first job seeker a fee.

### BRIEF DESCRIPTION OF THE DRAWINGS

FIG. 1 is a block diagram of multiple levels of referrals.

FIG. 2 is a block diagram of a first embodiment of the system of the invention.

FIG. 3 is a block diagram of a second embodiment of the device of the invention, a number of record objects in the database.

FIGS. 4A and 4B are a flow chart depicting a third embodiment of the method of the invention.

INDEX OF REFERENCE NUMERALS

| | |
|---|---|
| First job seeker | 102 |
| Second job seeker | 104 |
| Third job seeker | 106 |
| Payment event | 108 |
| First multi-level marketing fee | 110 |
| Second multi-level marketing fee | 112 |
| Third multi-level marketing fee | 114 |
| Server computer/website modules | 202 |
| Database | 204 |
| Internet/computer network | 206 |
| Client-side computer | 208 |
| Operative electronic connection | 210, 212, 214 |
| Database | 302 |
| Job opportunity object | 304 |
| Resume object | 306 |
| Referral object | 308 |
| Register employer step | 402 |
| Post job opportunity step | 404 |
| Register first job seeker step | 406 |
| Post first job seeker's CV step | 408 |
| Second job seeker is referred by first job seeker step | 410 |
| Register second job seeker step | 412 |
| Post second job seeker's CV step | 414 |
| Create referral object from 1^{st} to 2^{nd} seeker step | 416 |
| Repeat for additional referrals from 1^{st} seeker step | 418 |
| Repeat for additional referrals from 2^{nd} seeker step | 420 |
| Wait for hiring event | 422 |
| Consult payment rules table and issue fee step | 424 |

### DETAILED DESCRIPTION

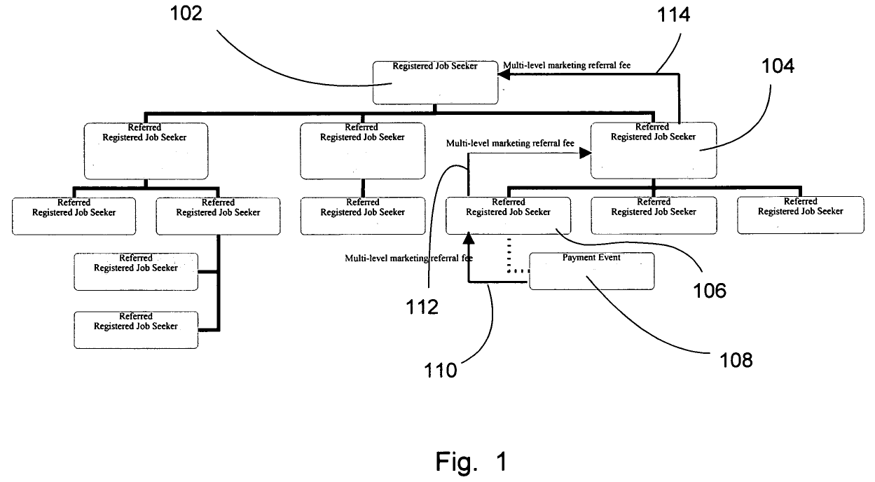

FIG. 1 is a block diagram of multi-level referrals and fee payments.

First job seeker 102 registers with the web-site of the invention and thereafter, refers second job seeker 104, who in turn registers and refers third job seeker 106. At each stage of the registration, the job seekers provide their resumes, and thus a collection of resumes may be built. The motivation for the referrals of job seekers by other job seekers is financial. That is, when a payment event 108 occurs, there may be multiple “marketing fees” to the various members of the referral network. First multi-level marketing fee 110, second multi-level marketing fee 112 and third multi-level marketing fee 114 may all be paid to various members of the network. Thus, first job seeker 102 may receive payment for the payment event relating to third job seeker 106, who he/she may not even know. This overcomes the traditional reluctance of job seekers to refer other job seekers to potentially very lucrative jobs or “job board” web-sites, and provides a new source for building a resume library (job seekers provide the referrals) and furthermore harnesses the power of multi-level marketing to the career development field.

Payment event 108 is in the preferred embodiment an actual hiring, but in alternative embodiments, the payment event may be an interview, a contract, a contact, placement on a temporary basis, a business relationship, provision of a resume and so on.

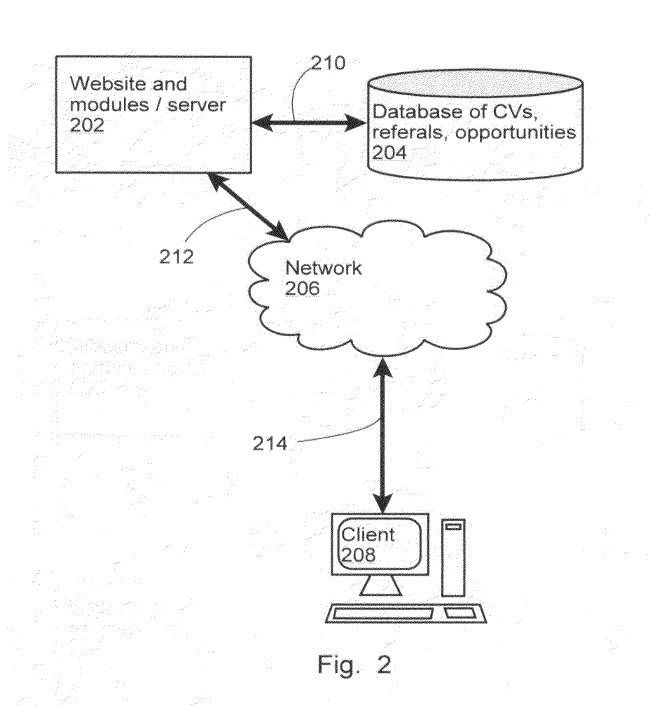

FIG. 2 is a block diagram of a first embodiment of the system of the invention. In the presently preferred embodiment and best mode presently contemplated for carrying out the invention, server computer 202 may have the website modules available thereon for download to users (employers, job seekers, head hunters or the general public) who visit the website. The website 202 may have various modules and functionality associated therewith. The website may have at least a first registration module allowing such first job seeker to register their contact information such as name, address, email address, telephone number and the like, as well as user name, password and so on. A second resume collection module allows job seekers to post their resume/curriculum vitae to the database, and a third invitation module allows “first” job seekers to refer “second” job seekers to the website, where the second tier job seeker may then do the same activities. A fourth payment module may contain a look up table or formula for calculation of finder's fees due to the individuals who made the referrals when a referred party is hired by means of the invention.

The website may have an operative connection 210 to the database 204. Strictly speaking, the website itself may be a program object in memory in the server computer, however, the invention is not so limited. The website will also have an operative electronic connection 212 to a computer network such as the Internet 206, by which means an operative electronic connection 214 to a client-side computer (such as a personal computer) may be made.

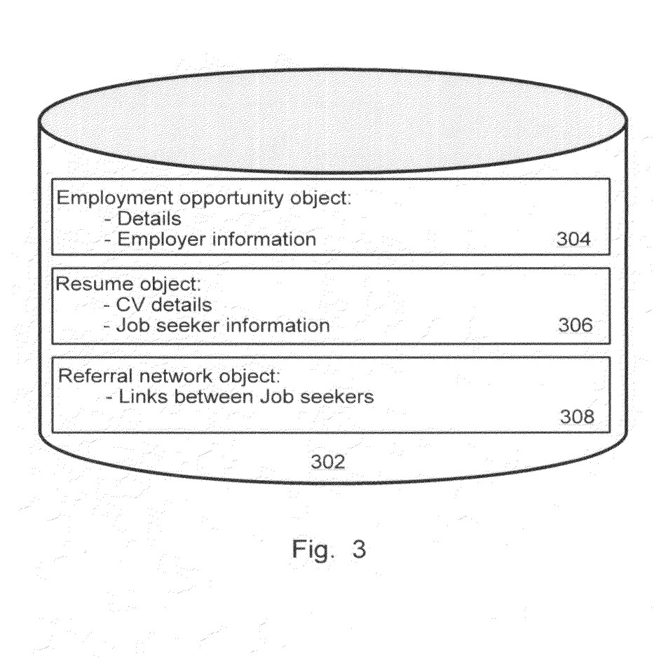

FIG. 3 is a block diagram of a second embodiment of the device of the invention, a number of record objects in the database.

The database 302 maintains several forms of records or objects. Records entered by employers 304 will naturally have job information, contact information, and job requirements and desired qualifications of the applicants. Resume object 306 on the other hand may be a record having therein CV details such as past work history, education and the like. Referral network record/object 308 may maintain at least a link or indication of a first relationship of such first and second job seekers, for example, that job seeker one referred job seeker two, leading to acquisition of the resume of job seeker two for the database.

Table One, below, outlines the essential steps of the system. Note that these steps will normally be running in parallel and concurrently both for “unrelated” individuals and employers and also, even for individual job seekers and employers who are simply able to carry out the steps of the invention when required, without regard to exemplary the numerical order below.

For example, a first job seeker might register, sign up (refer) a second job seeker, and the second might sign up a third and a fourth, before the first job seeker invites (refers) another “second” job seeker, and all of this may occur prior to an relevant job opening being posted by an employer.

TABLE ONE

| | |
|---|---|
| 1. | Register employer |
| 2. | Post job opportunity information |
| 3. | Register first job seeker |
| 4. | Post resume information |
| 5. | Second job seeker invited by first job seeker |
| 6. | Register second job seeker |
| 7. | Create referral record from second job seeker to first job seeker |
| 8. | Post resume information |
| 9. | Repeat steps 5 through 8 for additional referrals of first job seeker |
| 10. | Repeat steps 5 through 8 for referrals of second job seeker |
| 11. | If hiring event occurs, consult fee payment rules and pay |
| | referring job seekers |

Table Two illustrates the fact that the steps of the process may be reordered with a great deal of flexibility. In fact, a job opportunity may never be posted and yet may result in a multi-level payment event, as shown.

TABLE TWO

| | |
|---|---|
| 1. | Register first job seeker |
| 2. | Post resume information |
| 3. | Second job seeker invited by first job seeker |
| 4. | Register second job seeker |
| 5. | Create referral record from second job seeker to first job seeker |
| 6. | Post resume information |
| 7. | Repeat steps 5 through 8 for additional referrals of first job seeker |
| 8. | Repeat steps 5 through 8 for referrals of second job seeker |
| 9. | Employer registers |
| 10. | Employer searches database without posting job opening |
| 11. | If hiring event occurs, consult fee payment rules and pay referring |
| | job seekers |

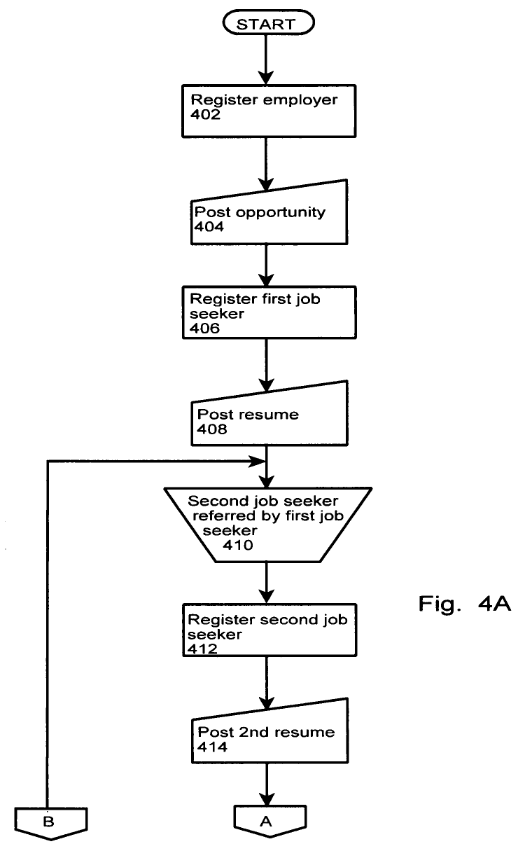

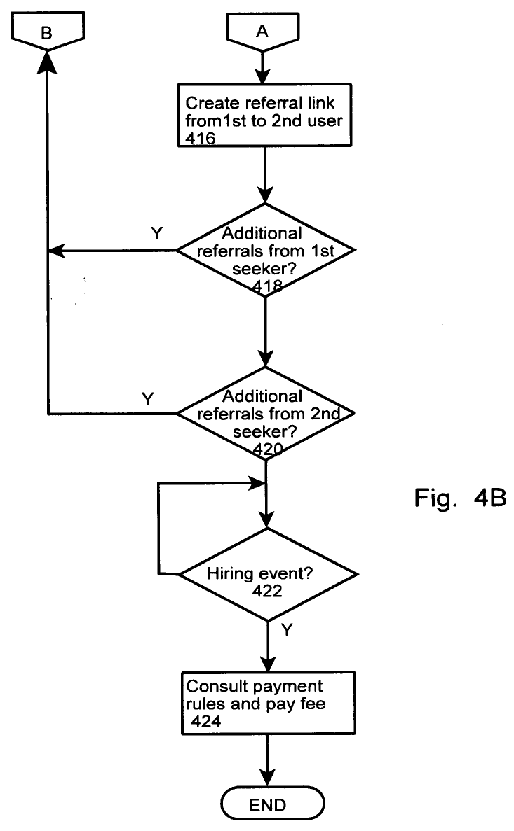

FIGS. 4A and 4B are a flow chart depicting a third embodiment of the method of the invention. Register employer step 402 allows an employer to register to use the website services. This may be a fee based service for employers as well, and revenues may be garnered by other means: advertisements, applicant fees and so on. The employer may then post job opportunity step 404, at which a job posting is publicized with typical details: location, pay, qualifications and so on.

Simultaneously, previously or later, a first job seeker registration step 406 allows a job seeker to register, providing contact information, name and so on. Optionally, the applicant may carry out post CV step 408, in which a resume is posted for the individual, having in the record of that resume the usual details associated therewith.

Crucially to the invention, a second job seeker is then referred by the first job seeker, at step 410. This draws on the power of personal relationships, interpersonal networking and the like: job seekers are often best positioned to know of other job seekers or even individuals who are not actively seeking employment but might be interested in a job offer the first job seeker has noted. The finder's fee to the first job seeker may ensure the interest of the first job seeker in hunting for such referrals.

Registration of second job seeker step 412 may be similar to or identical to the registration of the first job seeker, as may the optional posting of the second job seeker's CV step 414. However, the database of the system will have a new record (see object 308 of FIG. 3) created, a referral object from the 1^{st} job seeker to the 2^{nd} seeker (step 416). This may be a simple field, link, pointer or the like to indicate the referral. Each record/object/individual may have a number of pointers to them from individuals referred, as may be seen at step 418: the first seeker may recruit additional job seekers, not just one. Thus the second job seeker may be one of a of what may be termed a “second tier” or “second level” of job seekers. This then is,repeated for additional referrals from 2^{nd} seeker step 420, thus creating a third job seeker representative of a “third tier” or “third level” of job seekers.

This terms are relative terms, not absolute: the “first” job seeker may be any individual in the web, since they will be “first” from the standpoint of every individual below them in the next tier down.

When a hiring event (step 422) occurs, the device of the system will then consult a payment rules table or formula or rules and issue a finder's fee at step 424. Payment may be extremely flexible. A number of multi-level payment systems may be established within the scope of the invention. For example, only direct referrals (only the second tier referrals) may be a basis for a fee, or the chain of referrals might stretch out a long distance based upon a gradually diminishing return as the hired party becomes further removed from the “first” job seeker by more and more links of referrals. Thus the tables below are exemplary only and not limiting. In particular, simple formulation of amounts of finder's fees is presently preferred to look-up tables.

Table two displays a fee system which decreases by powers of one half for each link in the network of referrals. This may be carried out at a different fraction for each link, or it may simply terminate after a set maximum number of links, or it may carry on more or less indefinitely until the calculated amount becomes too small for financial services to handle.

TABLE TWO
FEE PAYMENT TABLE

For hiring of direct referral: X$
For hiring of second generation referral: X/2 $
For hiring of third generation referral: X/4 $

Table three on the other hand shows that an amount may be calculated based on factors relating to the hire, such as time of the hire relative to posting of opportunity or resume, or hiring salary, special incentive offers and so on and so forth: the system need not be limited strictly to a computation based upon multi-level referral order. Note that a simple payment system based upon a small number of factors (such as level of referrals) is presently preferred as this allows job seekers to quickly calculate (and be motivated by) the amount of finder's fee they may get for a successful referral hire. Thus in Table Three, M, N, P, and Q may all represent factors relating to the multi-level hiring.

TABLE THREE
FEE PAYMENT TABLE

For hiring of direct referral: A$ (A = M + ½ N)
For hiring of second generation referral: B$ (B = M + P)
For hiring of third generation referral: C$ (C = ½ M + Q)

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A resume collection system and database for use with a computer network and for use by employers and by first and second job seekers having a client computer operatively connected to such computer network; the resume collection system and database comprising:
a server computer having thereon a database and a website, the server computer operatively connected to such computer network and operative to provide the website to such client computer connected to the server computer via such computer network;
the website having at least a first registration module allowing such first job seeker to register their contact information;
the website having at least a second resume collection module allowing such first job seeker to post their resume/curriculum vitae to the database;
the website having at least a third invitation module allowing such first job seeker to refer such second job seeker to the website and allowing such second job seeker to use the modules of the website also;
the database maintaining a first relationship object indicating the identities of such first and second job seekers;
the website having at least a fourth payment module which, upon occurrence of a first triggering event pays to such first job seeker a first fee.

2. The resume collection system and database of claim 1, wherein the triggering event further comprises:
hiring of such second job seeker.

3. The resume collection system and database of claim 1, for use by a third job seeker, wherein the resume collection system and database further comprises:
a second relationship object indicating a relationship between such second job seeker and such third job seeker.

4. The resume collection system and database of claim 3, wherein the fourth payment module further is operative to pay a second fee to such first job seeker upon occurrence of a second triggering event.

5. The resume collection system and database of claim 4, wherein the second triggering event further comprises:
hiring of such third job seeker.

6. The resume collection system and database of claim 1, further comprising:
at least a fifth job posting module operative to allow such employers to post to the database a first job opportunity object.

7. The resume collection system and database of claim 1, further comprising:
at least a fifth job search module operative to allow the job seekers to search the database for the first job opportunity object.

8. A method of collecting resumes for a first, second and third job seeker, the method of collecting resumes comprising:
a) providing a website at which a first employer may post job opportunities;
b) registering such first job seeker;
c) allowing such first job seeker to refer such second job seeker;
d) if such second job seeker is hired by such first employer, paying to such first job seeker a fee.

9. The method of collecting resumes of claim 8, further comprising:
e) allowing such second job seeker to refer such third job seeker;
f) if such third job seeker is hired by such first employer, paying to such first job seeker a fee.
